(19) United States
(12) Patent Application Publication
(10) Pub. No.: US 2019/0127528 A1
(43) Pub. Date: May 2, 2019

(54) HIGH-DENSITY MICROPOROUS CARBON AND METHOD FOR PREPARING SAME

(71) Applicant: HUTCHINSON, Paris (FR)

(72) Inventors: Ksenia ASTAFYEVA, Montargis (FR); Bruno DUFOUR, Champagne sur Seine (FR); Sara-Lyne STALMACH, Montargis (FR); Philippe SONNTAG, Avon (FR)

(73) Assignee: HUTCHINSON, Paris (FR)

(21) Appl. No.: 16/094,282

(22) PCT Filed: Apr. 14, 2017
(86) PCT No.: PCT/FR2017/050898

§ 371 Date: Oct. 17, 2018

(30) Foreign Application Priority Data
Apr. 18, 2016 (FR) 1653417

(51) Int. Cl. C08G 73/06; C01B 32/05; C08K 5/524; C08J 3/075; C08J 9/28; H01G 11/32; H01G 11/24

(52) U.S. Cl. CPC C08G 73/0683; C08J 2379/04; C08K 5/524; C08J 3/075; C08J 9/286; H01G 11/32; H01G 11/24; C01P 2004/32; C01P 2006/11; C01P 2006/12; C01P 2006/14; C01P 2006/40; C08J 2201/0504; C08J 2205/026; C01B 32/05

(57) ABSTRACT

A gelled aqueous polymer composition made from a resin produced by polycondensation of at least: a polyhydroxybenzene R, preferably resorcinol, hexamethylenetetramine HMTA, an anionic polyelectrolyte PA, preferably phytic acid. An aerogel obtained by drying these microparticles, and porous carbon microspheres obtained from the gel microparticles by pyrolysis. A method for producing a polymerised aqueous gel, an aerogel and porous carbon microspheres. Electrodes and electrochemical cell prepared from the porous carbon particles.

The present invention relates to a composition of porous microparticles of organic gel in an aqueous medium and to their process of preparation from a polyhydroxybenzene, in particular resorcinol, from hexamethylenetetramine and from an anionic polyelectrolyte, in particular phytic acid. It relates to porous carbon microspheres obtained from these microparticles by drying and pyrolysis. The invention also relates to a process for the manufacture of a polymerized aqueous gel, of an aerogel and of microspheres of porous carbon. Finally, it relates to electrodes and to an electrochemical cell prepared from the porous carbon particles of the invention.

### STATE OF THE PRIOR ART

Supercapacitors are electrical energy storage systems which are particularly advantageous for applications requiring the conveying of high power electrical energy. The possibilities of rapid charges and discharges and the increased lifetime with respect to a high-power battery make supercapacitors promising candidates for many applications.

Supercapacitors generally consist of the combination of two conductive electrodes having a high specific surface, immersed in an ionic electrolyte and separated by an insulating membrane, referred to as “separator”, which makes possible ionic conductivity and prevents electrical contact between the electrodes. Each electrode is in contact with a metal collector which makes possible exchange of the electric current with an external system. Under the influence of a difference in potential applied between the two electrodes, the ions present within an electrolyte are attracted by the surface exhibiting an opposite charge, thus forming an electrochemical double layer at the interface of each electrode. The electrical energy is thus stored electrostatically by separation of the charges.

To a first approximation, the expression of the capacitance of such supercapacitors is identical to that of conventional electrical capacitors, namely:

C=ϵ·S/t

with:
ϵ: the permittivity of the medium,
S: the surface area occupied by the double layer, and
t: the thickness of the double layer.

The capacitances achievable within supercapacitors are much greater than those commonly achieved by conventional capacitors, this being as a result of the use of porous electrodes having a high specific surface (maximization of the surface area) and of the extreme fineness of the electrochemical double layer (a few nanometers).

The carbon-based electrodes used within supercapacitor systems necessarily have to be:

conducting, in order to ensure the transportation of the electric charges,

porous, in order to ensure the transportation of the ionic charges and the formation of the electrical double layer over a large surface area, and

chemically inert, in order to prevent any energy-consuming side reactions.

The energy stored within the supercapacitor is defined according to the conventional expression for capacitors, i.e.:

E=1/2·C·V²

in which V is the potential of the supercapacitance.

According to this expression, the capacitance and the potential are two essential parameters which it is necessary to optimize in order to promote the energy performance qualities. For applications in transportation and in particular for an electric vehicle, having a high energy density is necessary in order to limit the on-board weight and the on-board volume of supercapacitors. The potential used depends essentially on the type of electrolyte used, which can be organic or aqueous.

Carbon-based materials, in the powder or monolith form, prove to be the best suited to such applications. This is because they have a high specific surface (500 to 2000 m²·g⁻¹) and develop a porosity capable of forming electrochemical double layers necessary for energy storage.

J. Chmiola et al., Science Magazine, 2006, Vol. 313, 1760-1763, have shown that the size of the pores has a crucial role in the performance qualities of supercapacitors. In fact, the specific surface of carbon-based materials and the porosity of the electrode actually accessible by the electrolyte are essential factors in the establishment and optimization of the electrochemical double layer in order to improve the capacitance of the electrode.

A maximization of the performance qualities of the carbon-based electrodes requires an increase in the capacitance of the electrode, which depends on the accessible surface area, while reducing the pore volume of the materials. This is because this volume is occupied by the electrolyte. The greater the amount of electrolyte stored in the electrode, the greater its final weight and its final volume. The result of this is a reduction in its capacitance per unit weight (expressed in F/g of electrolyte-filled carbon) and in its capacitance per unit volume (expressed in F/cm³). By considering that the two electrodes of one and the same system have the same specific capacitance, reference is made to mean specific capacitances. The density of the electrodes and in particular the density of carbon participating in the composition of the electrodes are good indicators of the pore volume of the electrodes and, consequently, a high density very often means high capacitances, especially the capacitance per unit volume. Consequently, the density of the carbon is used subsequently as a criterion of morphology of the carbons determining their electrochemical performance.

Thus, a strong microporosity and a high density of the carbon would promote high capacitances.

One route for the preparation of porous carbons of high specific surface consists in pyrolyzing blocks of natural precursors. For example, Zhonghua Hu and M. P. Srinivasan, Mesoporous Materials, 1999, Vol. 27, 11-18, have described a method for the preparation of carbon of high specific surface starting from plant wastes, such as coconut shells. This method exhibits many disadvantages. This is because it is difficult to vary the porosity in order to optimize the amount of energy which can be stored. Furthermore, these carbon sources exhibit a great variability, and traces of metals liable to disrupt the operation of a supercapacitor may be present.

Carbons derived from carbides (R. Dash et al., Carbon, Volume 44, Issue 12, 2006, pages 2489-2497) have a very homogeneous and controlled pore size; however, the high cost of production of such carbons seriously restricts their elevation to the industrial scale.

FR 2009/000332 describes the use of monolithic carbons in supercapacitors having high capacitances per unit weight. These carbons are prepared by pyrolysis of resorcinol/formaldehyde (RF) gels. Resorcinol/formaldehyde (RF) resins are particularly advantageous in the preparation of porous carbon having a high porosity in the monolith form which can be used in supercapacitors. This is because they are very inexpensive, can be employed in water and make it possible to obtain different porosities and densities depending on the preparation conditions (ratios between reactants, catalyst, and the like). For example, A. M. ElKhatat and S. A. Al-Muhtaseb, Advanced Materials, 2011, 23, 2887-2903, describe such variations in structure and in properties which can be obtained by variation in the conditions of synthesis, of drying and of pyrolysis. Nevertheless, these carbons are obtained from formaldehyde, which can present problems of toxicity. Furthermore, in the carbons prepared from RF gels, the ratio of the micropore to mesopore surfaces is low. In point of fact, in the field of supercapacitors, the microporosity plays an important role in the formation of the electrochemical double layer.

The paper “A novel way to maintain resorcinol-formaldehyde porosity during drying: Stabilization of the sol-gel nanostructure using a cationic polyelectrolyte”, Mariano M. Bruno et al., Colloids and Surfaces, Physicochemical and Engineering Aspects, Elsevier, Vol. 362, No. 1-3, pp. 28-32, 2010, discloses a mesoporous monolithic carbon resulting from an aqueous RF chemical gel comprising, in addition to a basic catalyst based on sodium carbonate, a cationic polyelectrolyte consisting of poly(diallyldimethylammonium chloride) which makes it possible to retain the porosity of the gel subsequent to the drying thereof in air (i.e., without solvent exchange or drying by a supercritical fluid).

If it is desired to form an electrode from a carbon in the powder form by coating of a current collector, the irreversible monolithic chemical gels of the prior art exhibit the disadvantage of requiring an intermediate stage of conversion of the monolithic organic aerogel into an aerogel powder (to be agglomerated, with or without binder, in order to obtain the final electrode). Starting from a monolith, it is thus necessary to pass through a grinding stage which is expensive and difficult to control in terms of final particle size distribution. Furthermore, it is preferable, in order to increase the energy density of a supercapacitor, to use a wound configuration, in which the cell or cells of the supercapacitor are provided in the form of a cylinder consisting of layers of metal collectors coated with electrodes based on the active material and of the separator wound around an axis. The use of monolithic electrodes is not compatible with this cylindrical configuration as a result of the stiffness of the carbon-based active material.

D. Liu et al., Carbon, 2011, 49, 2113-2119, describe a method for the preparation of ordered mesoporous carbon powder prepared by polymerization of a resorcinol/hexamethylenetetramine system in water in the presence of a triblock copolymer and of an agent which reinforces its hydrophobic nature. However, this method involves the use of a large amount of copolymer, which is expensive, and results in carbons which have a mesoporous structure, whereas micropores are more favorable to high capacitances being obtained.

On the basis of one and the same resorcinol/hexamethylenetetramine system, FR 3 022 248 has described a method for the synthesis of carbons having a high micropore surface area. However, this method does not make it possible to vary the density of the carbon and thus that of the electrodes in order to raise the energy density per unit volume stored in the supercapacitor. Consequently, the porosity and the capacitance of such materials still remain to be improved.

The document WO2015/155419 teaches a gelled and crosslinked aqueous polymeric composition which makes it possible to obtain, by drying, an organic aerogel directly in the form of microparticles. This composition is formed by a preliminary dissolution in the aqueous phase of the RF precursors and of a water-soluble cationic polyelectrolyte P, followed by a precipitation of the prepolymer thus obtained and then by a dilution in water of the solution of the prepolymer. The aqueous dispersion of microparticles of a shear-thinning physical gel results, with a high yield, by crosslinking and then simple drying in an oven, in a powdered aerogel and in its porous carbon pyrolyzate with a porosity and a specific surface which are both very high and predominantly microporous. However, the density of these materials can be further improved with the aim of increasing the conductivity of the electrodes resulting from these carbons.

Another principle which makes it possible to increase the capacitive performance qualities of supercapacitors consists in chemically activating the surface of the carbon. The activation treatment results in a grafting of heteroatoms at the carbon surface in the form of functional groups exhibiting a redox activity (B. E. Conway, Electrochemical Supercapacitors—Scientific Fundamentals and Technological Applications, Springer, 1999, pp. 186-190). Different methods which make it possible to introduce heteroatoms into carbon-based materials have thus been described in the literature. The most conventional is an activation using oxygen.

The patent application EP 2 455 356 has shown an essential rise in the capacitance by virtue of the grafting of oxygen-comprising sulfate-comprising groups by impregnation with sulfuric acid. In particular, carbons doped with nitrogen (Guofu Ma et al., Bioresource Technology, 197, 2015, 137-142; K. Jurewicz et al., Electrochimica Acta, 48, 2003, 1491-1498) and phosphorus (D. Hulicova-Jurcakova et al., J. Am. Chem. Soc., 2009, 131, 5026-5027) have formed the subject of numerous studies in order to understand the beneficial effect of these dopings on the performance qualities of supercapacitors.

In addition, Xiaodong Yan et al., Electrochimica Acta, 136, 2014, 466-472, describe a synthesis of porous carbons enriched at the same time in nitrogen and in phosphorus by heat treatment of an H₃PO₄/polyacrylonitrile composite precursor.

Some carbon-based materials exhibit a doping with nitrogen at a high content (up to 20%) but their capacitance does not vary proportionally to their nitrogen content. Furthermore, the abovementioned papers describe materials in which the density of the carbon is fairly low.

An attempt has been made to develop a process which gives access to a dense carbon-based material which has an optimized micropore porosity and which is enriched in doping agents, in particular N and P. This combination of characteristics results in elevated electrochemical performance qualities. An attempt has also been made to develop a method of synthesis which is not very toxic to the environment and which can be easily extrapolated to the industrial scale.

### SUMMARY OF THE INVENTION

A first subject matter of the invention consists of a gelled aqueous polymeric composition based on a resin resulting from the polycondensation of at least the following monomers:

a polyhydroxybenzene R, preferably resorcinol,

hexamethylenetetramine HMTA,

an anionic polyelectrolyte AP with a molar mass of less than or equal to 2000 g/mol.

The invention also relates to a process for the manufacture of a gelled aqueous polymeric composition as defined above, this process comprising the following stages:
a) the mixing in an aqueous solvent of the polyhydroxybenzene(s) R and of the hexamethylenetetramine HMTA, so as to form a polycondensate,
b) the introduction into the product of stage a) of the anionic polyelectrolyte AP, preferably phytic acid,
c) the heating of the mixture of stage b).

According to a preferred embodiment, the anionic polyelectrolyte comprises nitrogen atoms or phosphorus atoms.

According to a preferred embodiment, the anionic polyelectrolyte is phytic acid HPhy.

According to another preferred embodiment, the anionic polyelectrolyte comprises several carboxylic acid functional groups.

According to a preferred embodiment, the anionic polyelectrolyte is chosen from: citric acid, oxalic acid, fumaric acid, maleic acid, succinic acid, ethylenediaminetetraacetic acid, polyacrylic acids or polymethacrylic acids.

According to a preferred embodiment, the composition is in the form of gel microparticles in an aqueous medium.

According to an optional embodiment, the monomers comprise at least one cationic polyelectrolyte.

According to a preferred embodiment, the AP/HMTA molar ratio is from 0.010 to 0.150, preferably from 0.015 to 0.140, better still from 0.020 to 0.130. According to a preferred embodiment of the process of the invention:

stage a) is carried out at a temperature ranging from 40 to 80° C.,

stage c) is carried out at a temperature ranging from 70 to 100° C.

According to a preferred embodiment of the process of the invention, stage b) comprises the addition of the anionic polyelectrolyte, preferably phytic acid, in the form of an aqueous solution in several goes to the product of stage a).

According to an optional embodiment, the process of the invention comprises a stage of addition of a cationic polyelectrolyte between stages b) and c).

According to an optional embodiment, the process of the invention comprises a stage of dilution with water of the composition of stage b).

The invention further relates to a process for the preparation of an aerogel which comprises the stages of the process for the preparation of the gelled aqueous polymeric composition and which additionally comprises a stage of drying in an oven.

The invention also relates to a process for the preparation of a porous carbon which comprises the preparation of an aerogel according to the process defined above and which additionally comprises at least one pyrolysis stage.

A further subject matter of the invention is a porous carbon in the form of microspheres liable to be obtained by the process defined above and which exhibits a density, measured by the tapped density method, of greater than or equal to 0.38 g/cm ³.

According to a preferred embodiment, the porous carbon exhibits a nonzero content of nitrogen and of phosphorus.

According to a preferred embodiment, the porous carbon exhibits a ratio of the micropore volume with respect to the sum of the micropore and mesopore volumes of greater than or equal to 0.70, measured by nitrogen adsorption manometry.

A further subject matter of the invention is an electrode which comprises a current collector coated with an active material composition comprising the porous carbon defined above.

The invention also relates to a supercapacitor cell comprising at least one electrode according to the invention, immersed in an aqueous ionic electrolyte.

The microspheres of the invention exhibit a high micropore specific surface, combined with a low pore volume and a high density.

The compositions of microspheres of the invention exhibit the advantage of being able to be obtained without using formaldehyde.

The process of the invention makes it possible to access carbons doped with nitrogen and with phosphorus without an additional doping stage after the formation of the carbon. In addition, the process of the invention exhibits several alternative forms which make it possible to adjust the content of doping elements of the carbon.

The process of the invention makes it possible to access powders of porous carbons having a ratio: micropore volume/(micropore+mesopore) volume which is greater than those of the powders of porous carbons of the prior art.

The process of the invention makes it possible to access powders of porous carbons having a micropore volume/mesopore volume ratio which is greater than those of the powders of porous carbons of the prior art.

These properties confer, on the porous carbons of the invention, better performance qualities when they are used to manufacture electrodes, in particular supercapacitor electrodes.

### DETAILED DESCRIPTION

The invention relates to a method for the preparation by the aqueous route of porous organic gel microparticles and of porous carbon microspheres doped with nitrogen and with phosphorus. By virtue of their high specific surface and their high density, these porous carbon microspheres can in particular be used as constituent of electrodes of supercapacitors. The method of the invention makes it possible to avoid the use of carcinogenic precursors, organic solvents or dispersants, it does not comprise a grinding stage and it does not require expensive tooling. By virtue of the high carbon density and of the presence of nitrogen and of phosphorus, it makes it possible to produce supercapacitors, the capacitance per unit volume of which is improved with respect to the prior art, without losing in capacitance per unit weight.

According to the IUPAC classification, micropores are defined as having a diameter of less than 2 nm, mesopores as having a diameter of 2 to 50 nm and macropores as having a diameter of greater than 50 nm.

The term “microspheres” is understood, within the meaning of the present invention, to mean particles, the volume median particle size of which, measured by a laser particle sizer in a liquid medium, is less than or equal to 1 mm.

The term “constituted essentially of” is understood to mean, on the subject of a product or of a process, that it is composed of the constituents or of the stages listed. It can optionally comprise other components or stages provided that these do not substantially modify the nature and the properties of the product or of the process under consideration.

Gelled Aqueous Polymeric Composition:

This composition is based on a resin resulting from the polycondensation of at least:

a polyhydroxybenzene R,

hexamethylenetetramine HMTA,

an anionic polyelectrolyte, preferably phytic acid HPhy.

It additionally comprises an aqueous phase.

The term “gel” or “gelled composition” is understood to mean, in a known way, the mixture of a colloidal material and of a liquid, which is formed, spontaneously or under the action of a catalyst, by the flocculation and the coagulation of a colloidal solution. Chemical gels and physical gels are distinguished: the first owe their structure to a chemical reaction and are by definition irreversible, while the second result from a physical interaction between the components and the aggregation between the macromolecular chains is reversible.

While a condensation reaction of a polyhydroxybenzene, such as resorcinol, with hexamethylenetetramine results in an irreversible monolithic chemical gel, the presence of an anionic polyelectrolyte, in particular phytic acid, in the medium results in the formation of a dispersion of gelled microspheres, that is to say a physical gel, based on microspheres which are themselves formed from a chemical gel.

Specifically, the inventors have discovered that phytic acid makes it possible, in the presence of polyhydroxybenzene and of hexamethylenetetramine, to form polymeric microparticles.

The gelled composition of the invention can be dried easily and rapidly by simple oven drying. This oven drying is simple to carry out and less expensive than the drying carried out by solvent exchange or by supercritical CO₂ which is taught in the prior art.

The composition of the invention retains the strong porosity of the gel subsequent to this oven drying and results in an aerogel having a high density combined with a high specific surface and a high pore volume. The gel according to the invention is mainly microporous, which makes it possible to produce an essentially microporous carbon by pyrolysis of this gel. The electrodes of supercapacitors obtained from this pyrolyzed gel have available a high specific energy and a high capacitance.

Mention may be made, among the polyhydroxybenzene monomers which can be used in the preparation of the resin of the invention, of: di- or trihydroxybenzenes, advantageously resorcinol (1,3-dihydroxybenzene). It is possible to plan to use several monomers chosen from polyhydroxybenzenes, such as, for example, the mixture of resorcinol with another compound chosen from catechol, hydroquinone or phloroglucinol.

The anionic polyelectrolytes which can be used in the invention are preferably characterized by a molar mass of less than or equal to 2000 g/mol, advantageously of less than or equal to 1000 g/mol. For example, mention may be made, as anionic polyelectrolytes which can be used in the formation of the resin of the invention, of the chemical compounds carrying one or more functional groups chosen from carboxylic acid, phosphoric acid, phosphonic acid or sulfonic acid functional groups.

Preferably, anionic polyelectrolytes are chosen from the compounds carrying several functional groups chosen from carboxylic acid and phosphoric acid functional groups.

Mention is very particularly made, among these anionic polyelectrolytes, of molecules comprising several carboxylic acid functional groups, such as, for example, citric acid, oxalic acid, maleic acid, fumaric acid, succinic acid or ethylenediaminetetraacetic acid (EDTA).

Mention may also be made of the derivatives of carbohydrate compounds, or monosaccharides, carrying one or more functional groups chosen from the functional groups: carboxylic acid, phosphoric acid or phosphonic acid. In particular, mention may be made, in this category, of phytic acid, oligomers of uronic acids, in particular oligomers of D-glucuronic acid and of D-N-acetylglucosamine, such as hyaluronic acid, oligomers of guluronic acid and of mannuronic acid, such as alginates, oligomers of α-D-galacturonic acid (pectin) with a molar mass of less than or equal to 2000 g/mol.

Mention may also be made of oligomers of vinylphosphonic acid, polyacrylic acids, polymethacrylic acids, with a molar mass of less than or equal to 2000 g/mol.

According to an advantageous embodiment, the anionic polyelectrolyte is a polyacrylic acid.

Said anionic polyelectrolytes can be used in the process of the invention in the form of salts, in particular of alkali metal or alkaline earth metal salts. For example, mention may be made of sodium polyacrylates.

Mention may more particularly be made, among the anionic polyelectrolytes which can be used in the formation of the resin of the invention, of: phytic acid, hyaluronic acid, polyvinylphosphonic acids.

The polyelectrolyte preferably used is phytic acid, which is also known under the name of myo-inositol hexaphosphoric acid (CAS No. 83-86-3).

The monomers participating in the formation of the resin of the invention can additionally comprise, optionally, one or more cationic polyelectrolytes, such as, for example, an organic polymer chosen from the group consisting of quaternary ammonium salts, poly(vinylpyridinium chloride), poly(ethyleneimine), poly(vinylpyridine), poly(allylamine hydrochloride), poly(trimethylammonioethyl methacrylate chloride), poly(acrylamide-co-dimethylammonium chloride) and their blends.

More preferably still, the cationic polyelectrolyte is a salt comprising units resulting from a quaternary ammonium chosen from poly(diallyldimethylammonium halide)s and is preferably poly(diallyldimethylammonium chloride) or poly(diallyldimethylammonium bromide).

Other monomers than those stated above can participate in the composition of the resin of the invention. Preferably, their content does not represent more than 20% by weight, with respect to the total weight of the main monomers (polyhydroxybenzene, hexamethylenetetramine, anionic polyelectrolyte, optionally cationic polyelectrolyte) participating in the composition of the resin, advantageously not more than 10% by weight, more advantageously still not more than 5% by weight, even better still not more than 1% by weight.

According to a first preferred alternative form of the invention, the resin comprises:

one or more polyhydroxybenzenes R, preferably resorcinol,

hexamethylenetetramine HMTA,

one or more anionic polyelectrolytes AP, advantageously chosen from the compounds with a molar mass of less than or equal to 2000 g/mol comprising several functional groups chosen from carboxylic acids and phosphoric acids, preferably phytic acid HPhy,

and these monomers represent at least 80% by weight, with respect to the total weight of the resin, better still at least 90%, advantageously at least 95% and more preferably still at least 99%.

More advantageously still, the resin is essentially formed of:

one or more polyhydroxybenzenes R, preferably resorcinol,

hexamethylenetetramine HMTA,

one or more anionic polyelectrolytes AP, advantageously chosen from the compounds with a molar mass of less than or equal to 2000 g/mol comprising several functional groups chosen from carboxylic acids and phosphoric acids, preferably phytic acid HPhy.

According to another preferred alternative form of the invention, the resin comprises:

one or more polyhydroxybenzenes R, preferably resorcinol,

hexamethylenetetramine HMTA,

one or more anionic polyelectrolytes AP, advantageously chosen from the compounds with a molar mass of less than or equal to 2000 g/mol comprising several functional groups chosen from carboxylic acids and phosphoric acids, preferably phytic acid HPhy,

one or more cationic polyelectrolytes CP,

and these monomers represent at least 80% by weight, with respect to the total weight of the resin, better still at least 90%, advantageously at least 95% and more preferably still at least 99%.

More advantageously still, the resin is essentially formed of:

one or more polyhydroxybenzenes R, preferably resorcinol,

hexamethylenetetramine HMTA,

one or more anionic polyelectrolytes AP, advantageously chosen from the compounds with a molar mass of less than or equal to 2000 g/mol comprising several functional groups chosen from carboxylic acids and phosphoric acids, preferably phytic acid HPhy,

one or more cationic polyelectrolytes CP.

Advantageously, in the composition of the invention, the ratio by weight R/W of the polyhydroxybenzene, preferably resorcinol, to the aqueous medium conforms to:

0.01≤R/W≤2,

more preferably still:

0.03≤R/W≤1.5,

better still:

0.05≤R/W≤1.

Advantageously, in the composition of the invention, the ratio by weight HMTA/W of the hexamethylenetetramine to the aqueous medium conforms to:

0.01≤HMTA/W≤1,

more preferably still:

0.03≤HMTA/W≤0.5.

Preferably, the molar ratio R/HMTA of the polyhydroxybenzene, preferably resorcinol, to the HMTA conforms to:

2≤R/HMTA≤4,

more preferably still:

2.5≤R/HMTA≤3.5.

Preferably, the molar ratio AP/HMTA of the anionic polyelectrolyte to the hexamethylenetetramine conforms to:

0.010≤AP/HMTA≤0.150,
preferably 0.015≤AP/HMTA≤0.140,
better still 0.020≤AP/HMTA≤0.130.

Advantageously, the molar ratio HPhy/HMTA conforms to:

0.010≤HPhy/HMTA≤0.150,
preferably 0.015≤HPhy/HMTA≤0.140,
better still 0.020≤HPhy/HMTA≤0.130.

Advantageously, the ratio by weight of the cationic polyelectrolytes to the polyhydroxybenzene, preferably resorcinol, conforms to:

0≤CP/R≤0.5.

The aqueous phase is essentially formed of water. It can comprise other components, such as, for example, surfactants, which are liable to influence the porosity of the microspheres and of the carbon (in particular anionic surfactants, nonionic surfactants). It can comprise salts. It can comprise acids or bases which will modify the pH and are thus liable to modify the kinetics of the polycondensation reaction.

Process for the Preparation of the Gelled Aqueous Polymeric Composition

The gelled aqueous polymeric composition of the invention is obtained by a process which comprises several alternative forms described below.

This process comprises:
a) the mixing in an aqueous solvent of the polyhydroxybenzene(s) R, preferably resorcinol, and of the hexamethylenetetramine HMTA, so as to form a polycondensate,
b) the introduction into the product of stage a) of the anionic polyelectrolyte AP, advantageously chosen from the compounds with a molar mass of less than or equal to 2000 g/mol comprising several functional groups chosen from carboxylic acids and phosphoric acids, preferably phytic acid,
c) the heating of the mixture of stage b).

On conclusion of stage b), a suspension of microspheres is formed which gels during stage c).

Preferably, this process first of all comprises the preparation of an aqueous solution of the polyhydroxybenzene(s) R, preferably resorcinol, and of an aqueous solution of the hexamethylenetetramine HMTA, the two solutions being mixed in order to form the polycondensate of stage a).

According to a preferred embodiment of the invention, the anionic polyelectrolyte, advantageously chosen from the compounds with a molar mass of less than or equal to 2000 g/mol comprising several functional groups chosen from carboxylic acids and phosphoric acids, preferably phytic acid, is prepared in the form of an aqueous composition which is subsequently introduced during stage b) into the polycondensate of stage a).

Preferably, stage a) is carried out at a temperature ranging from 40 to 80° C.

Preferably, stage c) is carried out at a temperature ranging from 70 to 100° C.

According to a first alternative form of the process of the invention, the aqueous solution of anionic polyelectrolyte, advantageously chosen from the compounds with a molar mass of less than or equal to 2000 g/mol comprising several functional groups chosen from carboxylic acids and phosphoric acids, preferably the aqueous solution of phytic acid, can be introduced in several goes, in particular in two goes, into the product of stage a) with optionally an intermediate storage of the composition of R/HMTA/AP microspheres at low temperature (greater than 0° C. and less than 10° C.).

According to a second alternative form of the process of the invention, the aqueous solution of anionic polyelectrolyte, advantageously chosen from the compounds with a molar mass of a less than or equal to 2000 g/mol comprising several functional groups chosen from carboxylic acids and phosphoric acids, preferably the aqueous solution of phytic acid, is introduced into the product of stage a) and then, after an optional resting time at low temperature (for example of greater than 0° C. and less than 10° C.), and before stage c), a cationic polyelectrolyte is introduced into the composition of R/HMTA/AP microspheres.

According to a third alternative form of the process of the invention, the aqueous solution of anionic polyelectrolyte, advantageously chosen from the compounds with a molar mass of less than or equal to 2000 g/mol comprising several functional groups chosen from carboxylic acids and phosphoric acids, preferably the aqueous solution of phytic acid, is introduced into the product of stage a) and then, after an optional resting time at low temperature (for example of greater than 0° C. and less than 10° C.), and before stage c), the composition of R/HMTA/AP microspheres is diluted with water.

According to the process of the invention, whatever the alternative form followed for the addition of the anionic polyelectrolyte, of the optional cationic electrolyte, of the optional dilution, the composition of microspheres obtained is subsequently subjected to a heating which makes possible a complete polymerization of the R/HMTA/AP system, in particular of the R/HMTA/HPhy system.

The size of the microspheres and their porosity is controlled as a function of the duration of the heating and of the dilution.

The doping of the carbon with elements P and N is controlled as a function of the amount of HMTA, of anionic polyelectrolyte, in particular of phytic acid, and optionally of cationic polyelectrolyte.

Surprisingly, if a cationic polyelectrolyte is introduced into the R/HMTA mixture on conclusion of stage a), a monolithic gel is obtained, whereas the addition of an anionic polyelectrolyte results in a suspension of microspheres.

Organic Aerogel:

The drying of the gelled aqueous composition of microspheres results in an organic aerogel in the form of a powder. Such a drying can be carried out in a known way in an oven.

The aerogel advantageously exhibits a porous structure which is predominantly microporous.

Carbon-Based Composition:

A further subject matter of the invention is a carbon-based composition obtained by drying and then pyrolysis of a gelled aqueous composition as described above.

The aerogel is subjected to a pyrolysis treatment, in a known way, in order to obtain a carbon powder which can be used in the manufacture of electrodes. The pyrolysis is typically carried out at a temperature of greater than or equal to 500° C., better still of greater than or equal to 600° C. The composition of gelled microspheres of the invention retains its porous structure, in particular its microporous structure, through the drying and pyrolysis stages.

Advantageously, this process can additionally comprise, on conclusion of the pyrolysis stage, a stage of activation of the porous carbon, this stage comprising an impregnation of the porous carbon with a strong sulfur-comprising acid, preferably with an acid in the form of a solution with a pH of less than or equal to 1, and which is, for example, chosen from sulfuric acid, oleum, chlorosulfonic acid and fluorosulfonic acid, as described in the document EP 2 455 356, or nitric acid. Preferably, sulfuric acid H₂SO₄ is used.

The carbon powder thus obtained exhibits advantageous properties:

It exhibits a density, measured by the tapped density method, of greater than or equal to 0.38 g/cm³, better still of greater than or equal to 0.39 g/cm³ and advantageously of greater than or equal to 0.40 g/cm³.

It exhibits a nonzero content of nitrogen and of phosphorus. Advantageously, it exhibits a nitrogen content of greater than or equal to 0.5% by weight, with respect to the total weight of the material, better still of greater than or equal to 1% and advantageously of greater than or equal to 1.5%. Advantageously, it exhibits a phosphorus content of greater than or equal to 0.01% by weight, with respect to the total weight of the material, better still of greater than or equal to 0.02% and advantageously of greater than or equal to 0.03%. According to an alternative form of the invention, the phosphorus content can be greater than 0.1%.

It exhibits a nonzero content of oxygen. Advantageously, it exhibits an oxygen content which can range up to 25% by weight, with respect to the total weight of the material, preferably from 8 to 17%.

It exhibits a ratio of the micropore volume, with respect to the sum of the micropore and mesopore volumes, of greater than or equal to 0.70, measured by nitrogen adsorption manometry.

It exhibits a ratio of the micropore volume, with respect to the mesopore volume, of greater than or equal to 2.20, measured by nitrogen adsorption manometry.

It exhibits a ratio of the micropore specific surface, with respect to the sum of the micropore specific surface and of the mesopore specific surface, of greater than or equal to 0.80, measured by nitrogen adsorption manometry.

It exhibits a ratio of the micropore specific surface, with respect to the mesopore specific surface, of greater than or equal to 7.00, measured by nitrogen adsorption manometry.

Electrodes and Supercapacitors:

The invention further relates to an electrode comprising a current collector and a layer of active material comprising the porous carbon of the invention.

In a known way, such an electrode is manufactured by the preparation of an ink comprising the porous carbon of the invention, water and optionally a binder, the deposition of this ink on the current collector, the drying of the ink. For the preparation of the electrode, reference may be made, for example, to the protocols described in the document FR 2 985 598.

The invention also relates to an electrochemical cell comprising such an electrode.

An electrode according to the invention can be used to equip a supercapacitor cell by being immersed in an aqueous ionic electrolyte, the electrode covering a metal current collector. Preferably, this electrode exhibits a geometry wound around an axis, for example a substantially cylindrical electrode.

The microporosity plays an important role in the formation of the electrochemical double layer in such a cell, and the porous carbons of the invention, which are predominantly microporous, make it possible to have available a high specific energy and a high capacitance for these supercapacitor electrodes.

Experimental Part:

### I—Materials and Methods:

Starting Materials:

TABLE 1
List of the precursors used

| Starting materials | Supplier |
|---|---|
| Resorcinol | Acros Organics |
| Hexamethylenetetramine (HMTA) | Sigma-Aldrich |
| Phytic acid (HPhy) | Sigma-Aldrich |
| Poly(diallyldimethylammonium chloride) | Sigma-Aldrich |
| Citric acid | Merck KGaA |
| Ethylenediaminetetraacetic acid (EDTA) | Sigma-Aldrich |
| Poly(acrylic acid, sodium salt) solution | Sigma-Aldrich |
| (PAA 1200) (*) | |
| Poly(acrylic acid) partial sodium salt | Sigma-Aldrich |
| solution (PAA 5000) (**) | |

(*) weight-average molecular weight Mw = 1200
(**) weight-average molecular weight Mw = 5000

Methods of Characterization:

Characterization by Nitrogen Adsorption Manometry:

The results presented in table 7 are obtained by nitrogen adsorption manometry at 77K on the Tristar 3020® and Asap 2020® apparatuses from Micromeritics.

Characterization by Mercury Porosimetry:

Mercury porosity measurements were carried out on the carbon-based materials (after pyrolysis) using a Poremaster® apparatus from Quantachrome.

Characterization by Volumetric Analysis (Tapped Density):

The carbon in the powder form is compacted by tapping a cylindrical measuring cylinder containing a known weight of carbon w for 30 min by the Volumeter Type Stay II® from Engelsmann (50 Hz). The powder density p is calculated as ρ=w/v, where V is the tapped powder final volume.

Characterization by Elemental Analysis:

The content of carbon, hydrogen, oxygen, nitrogen and sulfur was estimated by CHONS elemental analysis. The phosphorus content was measured using the ICP/AES apparatus from SDS Multilab. The nitrogen was also measured by the thermal conductivity according to the MO 240 LA 2008 method of SDS Multilab.

Electrochemical Characterization:

Carbon electrodes are produced from the porous carbon particles. For this, binders, conductive fillers, various additives and the porous carbon particles are mixed with water according to the protocol of FR 2 985 598, example 1. The formulation obtained is coated and then crosslinked on a metal collector coated beforehand with an aqueous dispersion from Timcal. Two identical electrodes are placed in series (isolated by a separator) within a measurement cell containing the electrolyte (ex. LiNO₃, 5M) and controlled by a potentiostat/galvanostat via a three-electrode interface. A first electrode corresponds to the working electrode and the second constitutes the counterelectrode and the reference is the calomel electrode.

For the measurement of the specific capacitance, the system is subjected to charge/discharge cycles at a constant current I of 0.5 A/g of the working electrode (each electrode is in turn a working electrode and a counterelectrode).

As the potential changes linearly with the charge conveyed, the capacitance C of the electrodes is deduced from the slopes p in the discharge (C=11p).

### II—Synthesis Protocols:

The protocols described below are employed using the components presented in table 2.

TABLE 2
Components of the initial protocol and of the protocols
1a, 2 and 3 and of the counterexamples

| | Ex. 1 | Ex. 2 | Ex. 3 | C. Ex. 1 | C. Ex. 2 | C. Ex. 3 |
|---|---|---|---|---|---|---|
| Resorcinol (R) (g) | 116.8 | 116.8 | 73.74 | 116.8 | 175.21 | 188.7 |
| Water (W) for dissolving R (g) | 116.8 | 116.8 | 147.48 | 116.8 | 175.21 | 233.6 |
| Hexamethylenetetramine (HMTA) (g) | 49.59 | 49.59 | 31.31 | 49.59 | 74.36 | — |
| Water (E) for dissolving HMTA (g) | 116.8 | 116.8 | 147.48 | 116.8 | 175.21 | — |
| Phytic acid (HPhy) 50% in H₂O (g) | 19.46 | 19.46 | 6.25- | 0 | — | — |
| | | | 36.87 | | | |
| Formaldehyde 37% (F) in H₂O (g) | — | — | | | — | 281.6 |
| Na₂CO₃ (C) (g) | — | — | | | — | 10.9 |
| Poly(diallyldimethylammonium | — | — | — | | — | 29.6 |
| chloride) (P) 35% by weight in H₂O | | | | | | |
| R/W (ratio by weight) | 0.29 | 0.29 | 0.18 | 0.29 | 0.5 | 1.13 |
| HMTA/W (ratio by weight) | 0.12 | 0.12 | 0.078 | 0.12 | 0.12 | — |
| R/HMTA (ratio in moles) | 3 | 3 | 3 | 3 | 3 | — |
| HPhy/HMTA (ratio in moles) | 0.042 | 0.042 | 0.021- | 0 | — | — |
| | | | 0.126 | | | |
| R/F (ratio in moles) | — | — | — | — | — | 0.5 |
| R/C (ratio in moles) | — | — | — | — | — | 174 |
| P/R (ratio in moles) | — | — | — | — | — | 6 × 10⁻⁴ |
| P/R (ratio by weight) | — | — | — | — | — | 0.055 |

In table 2, for the products employed in the diluted form, the amounts of products correspond to amounts of active material.

Initial Protocol (Common to All the Examples):

An organic gel is produced by the polycondensation of polyhydroxybenzene/resorcinol (R) with hexamethylenetetramine (HMTA), with or without addition of phytic acid (HPhy), according to the composition listed in table 2 above.

In a first step, the resorcinol is first dissolved in distilled water (the concentration can vary, see table 2). The dissolution of the hexamethylenetetramine is also carried out in water, brought to 50° C. by means of an oil bath. After dissolution, the solution of resorcinol in water is poured into the solution of HMTA in water and the temperature of the oil bath is brought to 80° C.

In a second step, the nonviscous mixture is prepolymerized in a reactor placed in an oil bath at 80° C. for approximately 40 min.

Protocol 1 (Examples 1a to 1 e):

Protocol 1.1: This protocol is applied to the mixture resulting from example 1. When the mixture of precursors becomes clear (at 68-71° C., after heating for 40-50 min), inositol hexakisphosphate (phytic acid) is added (19.46 g of aqueous solution of phytic acid with a concentration of 50% by weight) while mixing for 1 min, before cooling it in an ice bath.

A suspension of HMTA-resorcinol-phytic acid microspheres is obtained, which suspension is subsequently placed in a refrigerator (T=4° C.) for 24 h.

Protocol 1.2: The suspension of microspheres formed is then diluted in water, either with a polyelectrolyte, poly(diallyldimethylammonium chloride), denoted P in table 3, or with phytic acid, or with water. The mixture obtained is heated at reflux or in a heated oil bath in order to make possible complete polymerization of the HMTA-resorcinol-phytic acid system.

The experimental conditions related to the dilution and to the heating at reflux are listed in table 3.

The dispersion is subsequently left standing in order to make possible sedimentation of the HMTA-resorcinol gel or HMTA-resorcinol-phytic acid gel particles.

TABLE 3
Experimental conditions of protocol 1.2

| | Exam- | Exam- | Exam- | Exam- | Exam- |
|---|---|---|---|---|---|
| | ple 1a | ple 1b | ple 1c | ple 1d | ple 1e |
| Concentration by | 33 | 33 | 33 | 33 | 33 |
| weight of the gel (%) | | | | | |
| in the aqueous | | | | | |
| solution | | | | | |
| Concentration by | 1.88 | 1.88 | — | — | — |
| weight of the P in the | | | | | |
| water (%) | | | | | |
| Concentration by | — | — | 1 | 2 | — |
| weight of HPhy in the | | | | | |
| water (%) | | | | | |
| Temperature of the | 15 | 15 | 15 | 15 | 15 |
| gel during the dilution | | | | | |
| (° C.) | | | | | |
| Temperature of the | 95 | 85 | 85 | 85 | 85 |
| water during the | | | | | |
| dilution (° C.) | | | | | |
| Temperature of the | 98 | 86-92 | 86-92 | 86-92 | 86-92 |
| mixture at reflux (° C.) | | | | | |
| in the reactor | | | | | |
| Reflux/heating time (h) | 0.5 | 2 | 2 | 2 | 2 |
| Stirring rate (rpm) | 500 | 300 | 300 | 300 | 300 |

Protocol 2:

This protocol is applied to the composition of example 2 on conclusion of the initial protocol: When the mixture of precursors becomes clear (at 68-71° C., after heating for 40-50 min), the phytic acid is added (19.46 g of aqueous solution of phytic acid with a concentration of 50% by weight) and the mixture is left heating for a time T ranging from 15 to 120 min in order to obtain large HMTA-resorcinol-phytic acid microspheres which have adsorbed the water of the synthesis. The HMTA-resorcinol-phytic acid paste obtained is subsequently cooled in an ice bath for one hour.

TABLE 4
Heating conditions of example 2

| | Example 2a | Example 2b |
|---|---|---|
| Duration of the heating T (min) | 15 | 120 |

Protocol 3:

This protocol is applied to the composition of example 3 on conclusion of the initial protocol: When the mixture of precursors becomes clear (at 68-71° C., after heating for 40-50 min), the dilute phytic acid is added (at varied concentrations set out in table 5) and the mixture is left heating for 2 to 4 h in order to obtain HMTA-resorcinol-phytic acid microspheres which float in the solution. The suspension obtained is subsequently cooled in an ice bath for one hour.

TABLE 5
Conditions for implementation of protocol 3, examples 3a to 3d

| | Exam- | Exam- | Exam- | | Exam- |
|---|---|---|---|---|---|
| | ple 3a | ple 3b | ple 3c | | ple 3d |
| Concentration by | 50 | 100 | 100 | | 100 |
| weight of the initial | | | | | |
| gel (%) in the | | | | | |
| aqueous solution | | | | | |
| HPhy/HMTA ratio | 0.042 | 0.042 | 0.021 | | 0.126 |
| (mol) | | | | | |
| Concentration by | 50 | 3.9 | 2.0 | | 11.1 |
| weight of HPhy in | | | | | |
| the aqueous solution | | | | | |
| (%) added to the gel | | | | | |
| Heating time (min) | 240 | 240 | 240 | 240 | |

Examples 4, 5 and 6 and comparative example 4 are carried out with the same conditions and the same protocol as example 3a, the phytic acid being replaced with the anionic polyelectrolytes listed in table 5a. In these examples, the anionic polyelectrolyte/HMTA molar ratio is 0.042.

TABLE 5a
Choice of the anionic polyelectrolyte in examples
4, 5 and 6 and comparative example 4

| | Anionic polyelectrolyte |
|---|---|
| Example 4 | Citric acid |
| Example 5 | Ethylenediaminetetraacetic acid (EDTA) |
| Example 6 | Poly(acrylic acid, sodium salt) solution (PAA 1200) |
| Comparative | Poly(acrylic acid) partial sodium salt solution (PAA |
| example 4 | 5000) |

Final Protocol (Common to all the Examples):

This protocol is applied to all the examples, on conclusion of the synthesis of the suspension of microspheres. If the gel is in a dilute aqueous medium, the supernatant is recovered, in particular by filtration, so as to obtain a wet powder. If the gel is in a saturated aqueous medium, it is recovered directly in the form of a wet powder. The wet powder of HMTA-resorcinol-phytic acid microspheres is placed in an oven at 90° C. for 12 hours. The dried HMTA-resorcinol (counterexample 1) gel or HMTA-resorcinol-phytic acid gel particles are subsequently pyrolyzed at 800° C. under nitrogen in order to make it possible to obtain porous carbon particles. The carbon obtained is activated by impregnation by a 5M sulfuric acid solution for 1 h, followed by a heat treatment under nitrogen at 350° C. for 1 h.

Protocols of Counter Examples 1 to 3:

Counter example 1: the same conditions as in example 1 are applied but without phytic acid.

Counter example 2: example G1 of the patent application FR 3 022 248.

Counter example 3: synthesis of a pyrolyzed powdered resorcinol-formaldehyde gel according to the protocol of example G1 of WO2015/155419.

### III—Results:

Characterization by Nitrogen Adsorption Manometry:

The results of the measurements of the specific surfaces and of the pore volumes by nitrogen adsorption manometry are listed in tables 6 and 6a.

TABLE 6
Specific surface and pore volume - results of the nitrogen
adsorption manometry measurements on the materials studied

| | | Ex. 1a | Ex. 1b | Ex. 2a | Ex. 2b | Ex. 3a | Ex. 3d | Ex. 4 | Ex. 5 | Ex. 6 |
|---|---|---|---|---|---|---|---|---|---|---|
| Specific surface | micro + | 587 | 574 | 605 | 584 | 569 | 605 | 498 | 534 | 838 |
| (m² · g⁻¹) | meso | | | | | | | | | |
| | micro | 514 | 510 | 540 | 527 | 498 | 521 | 446 | 496 | 773 |
| | meso | 73 | 64 | 65 | 57 | 71 | 84 | 52 | 38 | 65 |
| Micro/micro + meso ratio | | 0.88 | 0.89 | 0.89 | 0.90 | 0.88 | 0.86 | 0.90 | 0.93 | 0.92 |
| Micro/meso ratio | | 7.04 | 7.96 | 8.31 | 9.24 | 7.01 | 6.20 | 8.6 | 13.1 | 11.9 |
| Pore volume | micro + | 0.26 | 0.25 | 0.25 | 0.24 | 0.25 | 0.27 | 0.22 | 0.22 | 0.36 |
| (cm³ · g⁻¹) | meso | | | | | | | | | |
| | micro | 0.20 | 0.20 | 0.21 | 0.20 | 0.19 | 0.20 | 0.16 | 0.19 | 0.25 |
| | meso | 0.06 | 0.05 | 0.04 | 0.04 | 0.06 | 0.07 | 0.06 | 0.03 | 0.11 |

| | | | | | | | | | |
|---|---|---|---|---|---|---|---|---|---|
| Micro/micro + meso ratio | 0.77 | 0.8 | 0.84 | 0.83 | 0.76 | 0.74 | 0.73 | 0.86 | 0.69 |
| Micro/meso ratio | 3.3 | 4.0 | 5.25 | 5.0 | 3.15 | 2.25 | 2.67 | 6.3 | 2.27 |

TABLE 6a
Specific surface and pore volume - results of the
nitrogen adsorption manometry measurements on the
materials studied for the comparative examples

| | | C. Ex. 1 | C. Ex. 2 | C. Ex. 3 | C. Ex. 4 |
|---|---|---|---|---|---|
| Specific surface | Micro + | 581 | 600 | 532 | 345 |
| (m² · g⁻¹) | meso | | | | |
| | micro | — | 558 | 470 | 318 |
| | meso | — | 82 | 62 | 27 |
| Micro/micro + meso ratio | | — | 0.93 | 0.88 | 0.92 |
| Micro/meso ratio | | — | 6.80 | 7.58 | 11.8 |
| Pore volume | micro + | 0.32 | 0.30 | 0.27 | 0.14 |
| (cm³ · g⁻¹) | meso | | | | |
| | micro | 0.21 | 0.22 | 0.18 | 0.12 |
| | meso | 0.11 | 0.08 | 0.09 | 0.02 |

| | | | | |
|---|---|---|---|---|
| Micro/micro + meso ratio | 0.65 | 0.73 | 0.66 | 0.86 |
| Micro/meso ratio | 1.9 | 2.75 | 2.0 | 6 |

It is observed that the materials of the invention exhibit a greater micropore volume/(micropore+mesopore) volume ratio than that of the materials of the prior art.

It is observed that the materials of the invention exhibit a greater micropore volume/mesopore volume ratio than that of the materials of the prior art.

Only the material of the prior art represented by counterexample 2 exhibits pore volume parameters comparable to those of the invention. However, this is a monolithic material, whereas the material of the invention is obtained directly in the powder form.

It is observed that the materials of the invention exhibit a micropore specific surface/(micropore+mesopore) specific surface ratio comparable to that of the materials of the prior art.

It is observed that the materials of the invention exhibit a micropore specific surface/mesopore specific surface ratio comparable to that of the materials of the prior art.

Characterization by Mercury Porosimetry:

The results of the mercury porosity measurements are represented in table 7:

TABLE 7
Results of the mercury porosimetry measurements
on the carbon-based materials

| | Ex. 1b | Ex. 2b | Ex. 3a | C. Ex. 3 |
|---|---|---|---|---|
| Macropore volume (cm³ · g⁻¹) | 1.010 | 0.491 | 0.575 | 0.698 |
| Mesopore volume (cm³ · g⁻¹) | 0.122 | 0.024 | 0.071 | 0.871 |
| Micro/meso ratio | 8.28 | 20.46 | 8.10 | 0.80 |

It is observed that the macropore volume/mesopore volume ratio is higher in the materials of the invention in comparison with the materials of the prior art.

Characterization by Volumetric Analysis (Tapped Density):

The measurement of the tapped density of the pyrolyzed carbons, in the powder form, is reported in table 8.

TABLE 8
Tapped density of the carbon powders

| | Tapped density (g/cm³) |
|---|---|
| Ex. 1a | 0.41 |
| Ex. 1b | 0.40 |
| Ex. 1c | 0.40 |
| Ex. 1d | 0.39 |
| Ex. 1e | 0.40 |
| Ex. 2b | 0.58 |
| Ex. 3a | 0.46 |
| Ex. 3b | 0.55 |
| Ex. 4 | 0.58 |
| Ex. 5 | 0.58 |
| Ex. 6 | 0.64 |
| C. Ex. 1 | 0.34 |
| C. Ex. 2 | Monolith |
| C. Ex. 3 | 0.34 |
| C. Ex. 4 | 0.56 |

It is observed that the carbon powders of the invention exhibit a density which is very significantly greater than that of the carbons of the prior art. The measurement cannot be applied to the carbon of counterexample 2, which is in the form of a monolith. The carbon of counterexample 4 exhibits a tapped density comparable to that of the carbons of the invention.

Characterization by Elemental Analysis

The results of the elemental analysis of the carbon-based materials (after pyrolysis) are presented in table 9:

TABLE 9
Elemental analysis of the carbon-based materials

| | Ex. 1a | Ex. 1b | Ex. 1d | Ex. 1e | Ex. 2b | Ex. 3a | C. Ex. 1 | C. Ex. 2 |
|---|---|---|---|---|---|---|---|---|
| C (% by weight) | 79.03 | — | — | — | — | — | 75 | — |
| H (% by weight) | 1.56 | — | — | — | — | — | 1.4 | — |
| O (% by weight) | 14.37 | — | — | — | — | — | — | — |
| N (% by weight) | 1.74 | 2.77 | 2.83 | 2.70 | 2.27 | 2.90 | 0.7 | |
| P (% by weight) | 0.22 | 0.37 | 0.143 | 0.101 | 0.044 | 0.039 | 0 | 0 |
| S (% by weight) | 0.003 | — | — | — | — | — | — | — |

It is observed that only the materials of the invention comprise both nitrogen and phosphorus.

Electrochemical Characterization:

The results of the measurements of the capacitances per unit weight and per unit volume of the electrodes are presented in table 10.

TABLE 10
Measurement of the capacitances per unit weight and per
unit volume of the electrodes prepared from the carbon-
based materials of the invention and of the prior art

| | Capacitance | Capacitance | Capacitance | Capacitance |
|---|---|---|---|---|
| | per unit | per unit | per unit | per unit |
| | weight | weight | volume | volume |
| | cathode | anode | cathode | anode |
| | (F/g) | (F/g) | (F/cm³) | (F/cm³) |
| Ex. 1a | 98 | 135 | 66 | 89 |
| Ex. 1b | 96 | 124 | 69 | 89 |
| Ex. 1c | 80 | 128 | 66 | 106 |
| Ex. 1d | 104 | 140 | 78 | 109 |
| Ex. 1e | 104 | 140 | 85 | 115 |
| Ex. 2a | 94 | 129 | 77 | 106 |
| Ex. 2b | 118 | 127 | 97 | 104 |
| Ex. 3a | 114 | 132 | 86 | 99 |
| Ex. 3b | 98 | 140 | 73 | 104 |
| Ex. 3c | 107 | 129 | 85 | 102 |
| Ex. 3d | 103 | 142 | 79 | 109 |
| Ex. 5 | 99 | 103 | 93 | 97 |
| Ex. 6 | 102 | 122 | 62 | 74 |
| C. Ex. 1 | 92 | 114 | 46 | 57 |
| C. Ex. 2 | 90 | 108 | — | — |
| C. Ex. 3 | 90 | 110 | 45 | 55 |

| | |
|---|---|
| C. Ex. 4 | Measurements not able to be carried out |

It is observed that the capacitances per unit weight of the electrodes obtained from the materials of the invention are in the majority of cases greater than those obtained from the materials of the prior art. The capacitances per unit volume of the electrodes obtained from the materials of the invention are, in all cases, very significantly greater than those obtained from the materials of the prior art. The measurements carried out on the electrode prepared from the material of counterexample 4 show that this electrode cannot be used as electrode.

1-20. (canceled)

21. A gelled aqueous polymeric composition based on a resin resulting from the polycondensation of at least the following monomers:
a polyhydroxybenzene R,
hexamethylenetetramine HMTA,
an anionic polyelectrolyte AP with a molar mass of less than or equal to 2000 g/mol.

22. The composition as claimed in claim 21, wherein the polyhydroxybenzene R is resorcinol.

23. The composition as claimed in claim 21, in which the anionic polyelectrolyte comprises nitrogen atoms or phosphorus atoms.

24. The composition as claimed in claim 23, in which the anionic polyelectrolyte is phytic acid HPhy.

25. The composition as claimed in claim 21 in which the anionic polyelectrolyte comprises several carboxylic acid functional groups.

26. The composition as claimed in claim 25, in which the anionic polyelectrolyte is chosen from: citric acid, oxalic acid, fumaric acid, maleic acid, succinic acid, ethylenediaminetetraacetic acid, polyacrylic acids or polymethacrylic acids.

27. The composition as claimed in claim 21, which is in the form of gel microparticles in an aqueous medium.

28. The composition as claimed in claim 21, in which the monomers comprise at least one cationic polyelectrolyte.

29. The composition as claimed in claim 21, in which the AP/HMTA molar ratio is from 0.010 to 0.150.

30. The composition as claimed in claim 21, in which the ratio by weight R/W of the polyhydroxybenzene, to the aqueous medium conforms to:
0.01≤R/W≤2.

31. The composition as claimed in claim 21, in which the ratio by weight HMTA/W of the hexamethylenetetramine to the aqueous medium conforms to:
0.01≤HMTA/W≤1.

32. The composition as claimed in claim 21, in which the molar ratio R/HMTA of the polyhydroxybenzene, to the HMTA conforms to:
2≤R/HMTA≤4.

33. A process for the manufacture of a gelled aqueous polymeric composition as claimed in claim 21, this process comprising the following stages:
a) the mixing in an aqueous solvent of the polyhydroxybenzene(s) R and of the hexamethylenetetramine HMTA, so as to form a polycondensate,
b) the introduction into the product of stage a) of the anionic polyelectrolyte AP,
c) the heating of the mixture of stage b).

34. The process as claimed in claim 33, in which:
stage a) is carried out at a temperature ranging from 40 to 80° C.,
stage c) is carried out at a temperature ranging from 70 to 100° C.

35. The process as claimed in claim 33, in which stage b) comprises the addition of the anionic polyelectrolyte, in the form of an aqueous solution in several goes to the product of stage a).

36. The process as claimed in claim 33, which comprises a stage of addition of a cationic polyelectrolyte between stages b) and c).

37. The process as claimed in claim 33, which comprises a stage of dilution with water of the composition of stage b).

38. The process as claimed in claim 33, wherein the polyhydroxybenzene R is resorcinol.

39. The process as claimed in claim 33 which additionally comprises a stage of drying in an oven to prepare an aerogel.

40. The process as claimed in claim 39 which additionally comprises at least one pyrolysis stage to prepare a porous carbon.
